(19) United States
(12) Patent Application Publication
(10) Pub. No.: US 2007/0186587 A1
(43) Pub. Date: Aug. 16, 2007

(54) Method for the manufacture of foam glass pellets

(75) Inventor: Hans-Veit Dennert, Schlusselfeld (DE)

Correspondence Address: BROWDY AND NEIMARK, P.L.L.C.;624 NINTH STREET, NW, SUITE 300, WASHINGTON, DC, 20001-5303, US

(73) Assignee: Dennert Poraver GmbH, Postbauer-Heng (DE)

(21) Appl. No.: 10/592,379

(22) PCT Filed: Mar. 1, 2005
(86) PCT No.: PCT/EP05/02120

§ 371 Date: Sep. 12, 2006

(30) Foreign Application Priority Data
Mar. 12, 2004 (DE) 10 2004 012 598.8

(51) Int. Cl. C03B 19/08; B29C 65/00

(52) U.S. Cl. 65/22; 264/43

(57) ABSTRACT

Foam glass pellets are manufactured by producing a raw preparation from the components of water, pre-milled or pre-crushed glass, waterglass and expanding agent; wet milling the raw preparation into slurry for several hours; pelletizing the slurry into green pellets; and foaming the green pellets into foam glass pellets.

The invention relates to a method for the manufacture of foam glass pellets.

Foam glass pellets are known to be made from the components of glass—in particular recycling glass in the form of vessel and window glass—waterglass and an expanding agent such as sugar or manganese. Proceeding from a pre-milled or pre-crushed condition, the glass is ground into glass powder by dry milling for example in ball mills. The particle size ranges between approximately 1 and 100 μm, with a size distribution typically having a maximum at approximately 50 μm. This glass powder is added to an aqueous glass-binder slurry of water, expanding agent and water glass as a binder in a mixing tank and stirred for a certain time of decomposition of the glass components. Then the slurry that has formed by stirring is pelletized in a pelletizing mixer—as a rule by the addition of further glass powder or return fines—or in a spray tower, forming dried so-called green pellets. Finally, these green pellets are foamed for example in a revolving tubular furnace at temperatures of typically 800 to 900° C.

In connection with the manufacture of foam glass pellets, it has fundamentally been known that the properties of the pellets considerably depend on the homogeneity of the glass powder particles as well as on the decomposition of these particles by so-called hydrolytic attack or alkaline attack by sodium lye, this being due to the hydrolytic interaction of glass in water or to the lye that exists—for example through waterglass—in the aqueous glass solution. In this decomposition, silanol groups form on the surface of the glass particles, these silanol groups, which may be enriched by water molecules depending on the sort of glass, being called silica gel layer because of their gel-type nature. It constitutes an essential factor in bonding to each other the glass particles in the binder matrix, thus influencing practical properties of the foam glass pellets, such as strength, uniform pore distribution within individual pellets, surface continuity and density.

In practice, various approaches to improvements have been made, such as increasing milling fineness in the dry milling step, rising dwell times of the complete raw preparation in an agitator tank, adding hot water to the raw preparation for increased reactivity etc. Nevertheless optimizing foam-glass pellets is still in need of improvement.

It is an object of the invention to specify a method for the manufacture of foam glass pellets by which to obtain a product of considerably improved properties, based on reduced requirements of implementation.

This object is attained by the following steps according to the characterizing part of claim 1:
producing a raw preparation from the components of water, pre-milled or pre-crushed glass, waterglass and expanding agent;
wet milling the raw preparation for several hours to obtain slurry;
pelletizing the slurry into green pellets; and
foaming the green pellets to obtain foam glass pellets.

Fundamentally, the prior art practice of dry milling the glass raw material is given up for wet milling the entire raw preparation of the essential components of water, glass, waterglass and expanding agent. Surprisingly, the green pellets thus produced lead to foam glass pellets of lower piled weight, higher strength, more uniform pore distribution within the individual particles, and increased particle-surface continuity and density. The reason for this extensive improvement of properties is to be found primarily in the effects, obtained by wet milling, of increased milling homogeneity accompanied with the formation of a rather distinct and thick layer of silica gel on the surface of the particles of the slurry. This implies that clearly improved decomposition of glass particles is attained in a combined process of milling and decomposing. As compared to prior art methods, separate dry milling of pre-crushed or pre-milled glass products and subsequent decomposition in an agitator tank is saved, which leads to rationalization also in terms of machinery and equipment. Upon wet milling, shear and friction of the grinding stock takes place by the auxiliary grinding balls rolling in the mill, which is accompanied with hydrolytic and alkaline attack by the presence of added waterglass in the wet mill. This “process of decomposition”, which is a chemical attack, aids in the mechanical comminution of the glass particles. Another contribution to improved product properties resides in that wet milling will bond more water in the particles of the slurry, this water acting as sort of a “fluxing agent” in the foaming process in addition to the free water still available as residual moisture in the green pellets. This works in favour of melting phases occurring at an earlier stage and, consequently, fine-pore inclusion of reaction gases. In addition to its job as a binder, the waterglass, which is an alkali silicate solution, also serves as a fluxing agent upon pelletization at increased temperature—again upon foaming. Of course, there is the prerequisite of water ions being available, which will again accelerate the melting process. At temperatures above 600° C. during the foaming process, the waterglass matrix, which is highly reactive due to wet milling, leads to increased solubilization and ion exchange with the glass particles, conditioning, among other things, clearly inferior solubility in water of the foamed glass as compared to original green particles.

Preferred embodiments of the invention specify further parameters of the method, for details of which, so as to avoid repetition, reference is made to the ensuing description of an exemplary embodiment of the method according to the invention, taken in conjunction with the drawing.

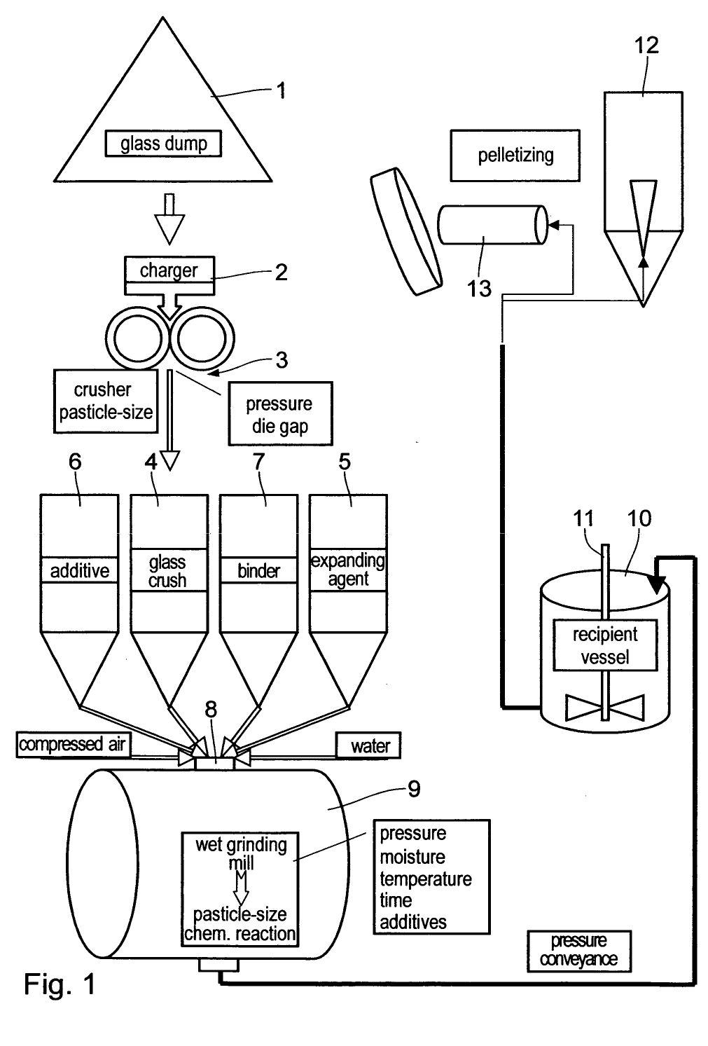

FIG. 1 is a flow diagram of a method for the manufacture of foam glass pellets;

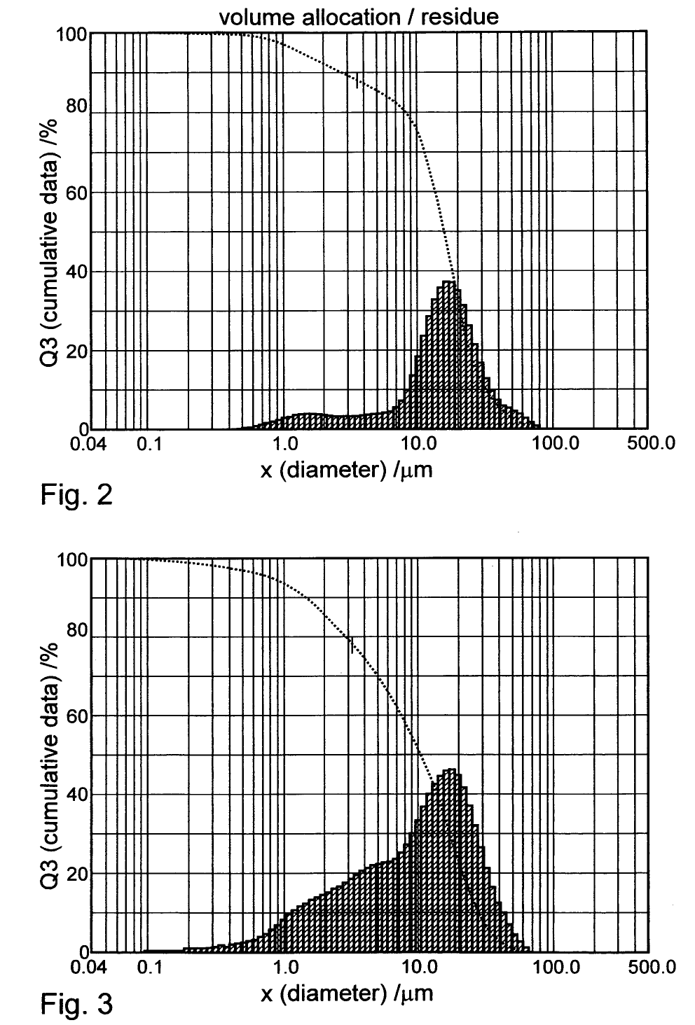

FIGS. 2 and 3 are particle-size distribution diagrams of dry and wet milled slurry particles; and

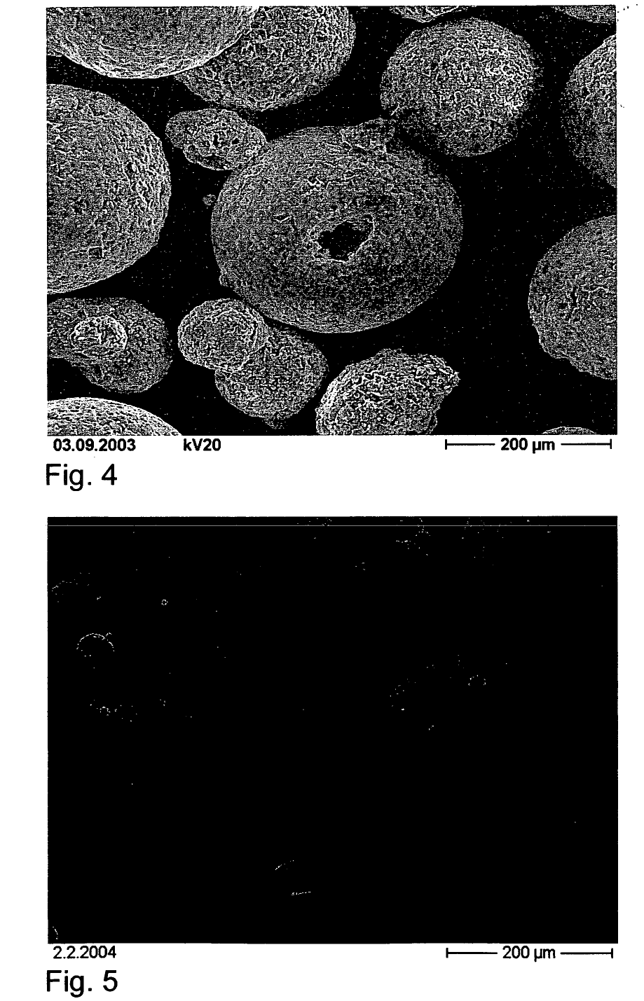

FIGS. 4 and 5 are SEM pictures of spray dried green pellets based on dry milled glass and wet milled slurry.

The method according to the invention proceeds from a mix of container and window recycling glass banked out on a dump 1, with however other sorts of glass being conceivable just as well. This recycling glass passes via a charger 2 to a crusher 3 where it is crushed into particles of a size of few millimeters. The crushed glass is temporarily stored in a storage bin 4. Similar bins 5, 6 hold the pulverulent expanding agent, such as sugar or manganese, and possibly additives, such as so-called intermediate oxides in the form of CaO, Al₂O₃, MgO or the like, which stabilize the glass matrix by working as network formers. A storage tank 7 holds the sodium silicate waterglass which also belongs to the raw preparation.

A mixing unit 8 serves to produce a raw preparation from the above components by the addition of water, the raw preparation being fed to a wet grinding mill 9 by charges, for example by charges of a metric ton.

Related to the dry mass of the components, the raw preparation is composed as follows:

83.5 to 94.5 percent by weight of pre-crushed glass;

5.0 to 15.0 percent by weight of waterglass (dry percentage); and

0.5 to 1.5 percent by weight of expanding agent.

The “dry percentage” of waterglass is to be understood as the solid components thereof that figure in the above dry recipe. The waterglass itself is sodium silicate waterglass, having a moisture of 50 to 80 percent, preferably approximately 55 percent.

Put in concrete terms, a recipe may for instance comprise 93 percent by weight of pre-crushed glass, 6 percent by weight of waterglass and 1 percent by weight of expanding agent. Intermediate oxides from the bin 6 can be added in proportions of 1 to 10 percent by weight, replacing the glass portion. The kind and extent of intermediate-oxide addition depend on the nature of the other raw materials employed and can be determined without any difficulties by practical tests.

For wet milling, the raw preparation is mixed with such a quantity of water that it has a moisture of 35 to 45 percent, inclusive of the water that originates from the waterglass.

This raw preparation is milled for four hours in the wet grinding mill 9. It has been found that, owing to mechanical destruction in the presence of a surplus of an aqueous alkaline solution (water and waterglass), a higher degree of fineness of grinding stock is obtained with the same input of energy as in dry milling, or that less energy is needed in case of predetermined milling fineness. This is confirmed by corresponding particle-size analyses as seen in FIGS. 2 and 3.

FIG. 2 illustrates the particle-size distribution Q3 of slurry based on dry milled glass powder in dependence on a particle diameter x. The histograms show a curve similar to a Gaussian curve, having a maximum at approximately 20 μm.

FIG. 3 illustrates a corresponding distribution in the case of wet milling for six hours. The percentage of particles between 1 and 10 μm is clearly higher than in the case of dry milling with the maximum in approximately the same position, which results in improved homogeneity of the particle mix. The reason for this improved grinding behaviour resides in that hydrate ions from the alkaline aqueous solution enter into the fissures produced in the glass particles by mechanical strain, which leads to stresses in the glass by silanol groups forming. Accompanied with only slight mechanical energy input, these silanol groups incite destruction of the particle. The alkaline aqueous fluid in the wet grinding mill 9 works as a sort of grinding aid. With it further providing for increased formation of a silica gel layer on the particle surface as mentioned at the outset, this component of the recipe is typically multifunctional, because it also works as a binder and fluxing agent. Four to ten hours can be specified as a range of time for wet milling.

By admission of compressed air, the slurry of a moisture of 35 to 45 percent is pumped from the wet grinding mill 9, where it has been produced, to a recipient vessel 10 which only serves as an intermediate buffer. Although the slurry, owing to its thixotropic properties, hardly tends to sediment, it is permanently stirred slightly by an agitator 11 for maintenance of its homogeneity.

Coming from the recipient vessel 10, the slurry is worked into green pellets for example by way of a spray tower 12 or a fluidized-bed pelletizer 13. These pellets have a residual free moisture of 0.1 to 0.5 percent. The method according to the invention can do without any addition of dried return fines as frequently used in prior art pelletizing methods that include disk pelletizers or pelletizing mixers. Of course, the wet milled slurry—like the slurry based on dry milled glass—can be worked into green pellets by a pelletizing mixer with the metered addition of dry return fines. However, the slurry prepared by wet milling furnishes by far more homogeneous green pellets by spray-tower pelletizing, which becomes apparent from a comparison of FIGS. 4 and 5. FIG. 4 is an SEM picture of green pellets produced on the basis of conventional dry milling. FIG. 5 shows spray-dried green pellets on the basis of wet milled slurry according to the invention. The surface of these green pellets is clearly more continuous, homogeneous and smooth.

The green pellets produced in the way described above are conventionally expanded at 800 to 1000° C. in a revolving tubular furnace, forming foam glass pellets, which is not illustrated in FIG. 1.

1-8. (canceled)

9. A method of manufacturing foam glass pellets, comprising the steps of:
producing a raw preparation from components including water, pre-milled or pre-crushed glass, waterglass and expanding agent;
wet milling the raw preparation into slurry for several hours;
pelletizing the slurry into green pellets; and
foaming the green pellets into foam glass pellets.

10. A method according to claim 9, wherein related to a dry mass of the components, the raw preparation comprises
80 to 98 percent by weight of pre-milled or pre-crushed glass;
1.5 to 17.0 percent by weight of waterglass (dry percentage); and
0.2 to 3.0 percent by weight of expanding agent.

11. A method according to claim 9, wherein the raw preparation and thus the slurry have a moisture of 25 to 60 percent, preferably of 35 to 45 percent.

12. A method according to claim 9, wherein a wet milling time period ranges between 1 and 10 hours.

13. A method according to claim 9, wherein pelletizing the slurry into green pellets of a residual free moisture of 0.1 to 5.0 percent, 0.5 percent, takes place in a spray tower (12) without the addition of dry return fines.

14. A method according to claim 9, wherein pelletizing the slurry takes place by fluidized-bed pelletizing (13).

15. A method according to claim 9, wherein prior to wet milling, intermediate oxides, such as CaO, MgO, Al₂O₃, B₂O₃ or the like, are added to the raw preparation in a percentage of 1 to 10 percent by weight, replacing the glass portion.

16. A method according to claim 9, wherein the raw preparation is wet milled, forming a slurry of a range of particle size between 0.5 and 100 μm.
